(19) United States
(12) Patent Application Publication
(10) Pub. No.: US 2010/0200662 A1
(43) Pub. Date: Aug. 12, 2010

(54) METHOD FOR PRODUCING A DEVICE COMPRISING A RADIO FREQUENCY TRANSPONDER ANTENNA WITH TWO TERMINAL SECTIONS PROVIDED ON A SUPPORT AND DEVICE THUS OBTAINED

(75) Inventors: Jean-François Martinent, La Ciotat (FR); Laurence Robles, Saint Zacharie (FR); François Roussel, Roquefort La Bedoule (FR)

Correspondence Address: BUCHANAN, INGERSOLL & ROONEY PC, POST OFFICE BOX 1404, ALEXANDRIA, VA, 22313-1404, US

(73) Assignee: GEMALTO SA, Meudon (FR)

(21) Appl. No.: 12/601,125

(22) PCT Filed: May 19, 2008
(86) PCT No.: PCT/EP2008/056123

§ 371 Date: Apr. 14, 2010

(30) Foreign Application Priority Data
May 21, 2007 (EP) 07301056.3

(51) Int. Cl. G06K 19/077; H01P 11/00

(52) U.S. Cl. 235/492; 29/600; 29/601

(57) ABSTRACT

The invention relates to a method for producing a device comprising a radio frequency transponder antenna, said method comprising a step of producing the antenna with two terminal sections (15, 17) on a support by means of a wiring technique. The method is characterised in that it comprises a step of producing an end point (9) on an antenna wire at the end of at least one of said terminal sections (5, 15, 17).

The invention further relates to the device thus produced.

The invention relates to a method for producing a device comprising a radio frequency transponder antenna, said method including a step of producing the antenna with two terminal sections on a support by means of a wiring technique.

More particularly, the invention aims at the production of a contactless chip card and/or a travelling document such as an electronic passport, an electronic visa, an electronic label, and an “inlay” or any electronic radiofrequency communication product intended to include a connection of a module to an antenna.

Among the methods for producing a transponder, using a wiring antenna in the body of a plastic material card through the ultrasonic inlay of a wire is known. The module is then connected by a thermo-compression soldering with the same antenna wire to connection pads or dies of an electronic component.

For the soldering, the conducting wire is placed in contact with the contact pads of a module or connection dies of an electronic chip and a thermo-compression probe is applied onto the wire, against the pad or die.

The utilisation of wire antenna production techniques is also known, which come from the textile field such as sewing, embroidery which use a textile or fibrous support.

This later technique experienced by the inventors demonstrated the need to implement beginnings and/or ends of embroidery or sewing which can be stopped more particularly by several passages of the wires or needles at the same place. These stitches are made so that it is possible to pull the wires beforehand and/or to cut the same and to stabilise the same on the support.

These backing stitches create either an additional thickness from 200 to 600 μm since the conducting wire is 100 μm and/or “idle” residual wire end which could affect the subsequent steps more particularly the lamination or the radio frequency characteristic of the antenna. This can also affect the appearance of the support and the connection of a module.

According to one embodiment of the invention, in order to facilitate the implementation of the wire of an embroidered antenna, the latter is an association or a combination of one or several conducting wires with one or several other wires made of synthetic fibres (PA: polyamide, cotton, PES: polyester). Upon the connection of the wires to the module by means of a thermo-compression, by pressing on the wire with the probe, more particularly carried out in a conventional way, the inventors noted a deterioration of the soldering tool since the latter was polluted by the non conducting fibres.

The invention aims at solving the above-mentioned problems met during the development of a new technology of a low cost mass-produced transponder antenna, more particularly the problem of the additional thickness of the wire and the production of the soldering tool.

The first problem is solved by making end points and the beginning and/or end of the antenna path; then the removal of the additional thickness and/or idle residual wire end.

The second problem is solved by providing another construction of the device and placing the module so as to enable the soldering in the soldering probe/module connection pads/conducting wire direction.

For this purpose, the invention aims at a method for producing a device comprising a radio frequency transponder antenna, said method including a step of producing the step of producing the antenna with two terminal sections on a support by means of a wiring technique.

The method is characterised in that it comprises a step of producing an end point on an antenna wire at the end of at least one of said terminal sections.

Thanks to this step, the antenna wire is stabilised and the pulling and cutting of the wire can be appropriately executed at a high rate.

According to other characteristics of the method:
said method includes a step of removal of said end point thus eliminating the problems of the additional thickness and the idle wire;
the step of removal includes the removal of material from the support opposite the end point and the formation of a cavity just enabling the insertion of a module into the cavity and a reduction in the thickness of the assembly;
the antenna terminal sections or end points are superimposed or provided in a support zone intended to be removed thus enabling a precise preparation of the antenna terminal ends to be connected in addition to the partial module inclusion;
the end point is selected among sewing, embroidery or knitting barring stitches, which are wiring techniques allowing high rates;
conducting pads are placed opposite said terminal sections and said contact pads are connected to the terminal wire sections by soldering the transfer of energy through said contact pads; this disposition thus prevents the soldering tool from being soiled;
an electronic component is fixed to the contact pads, the pads being previously connected to the antenna or previously to the component like a module;
the component is positioned at least partially into said cavity;
the support includes a fabric and a step of fixing a material stabilising and reinforcing the fabric.

Another object of the invention is a device including a radio frequency transponder antenna, with said antenna being produced with two terminal sections on a support.

The device is characterised in that at least one of said sections extends up to the edge of a cavity, thus enabling a precise preparation of the antenna ends for a correct connection and precise positioning of a module or chip, with the contact pads thereof in the cavity.

Thus, the contact pads do not need to extend much on the substrate since the antenna end is precisely located up to the edge.

This advantageous accurate positioning of the component to be connected relative to the antenna ends can be applied whatever the implemented antenna production technique: wiring, embroidery, etching, screen printing, etc. With the component positioned in the cavity, the antenna ends are necessarily on the edge since the operation of removing at least a part of the antenna and/or the support at the chip or module placing zone defines new ends at the edge of the removal zone.

The dimensions of the component can also be adapted to a placing and/or reception zone (cavity), as close as possible to the terminal sections of the antenna which are defined after the production of the antenna.

Thus, the invention also led to a method for precisely positioning and adapting to the dimensions of a component to be connected with respect to the terminal sections of antennas and to the product obtained.

The aim of the invention is also an electronic radio frequency communication product such as a contactless chip card, a passport, an inlay including the above mentioned device.

Other characteristics and advantages of the invention will appear upon reading the following description which is given as an illustrative and non limitative example and referring to the appended drawings wherein:

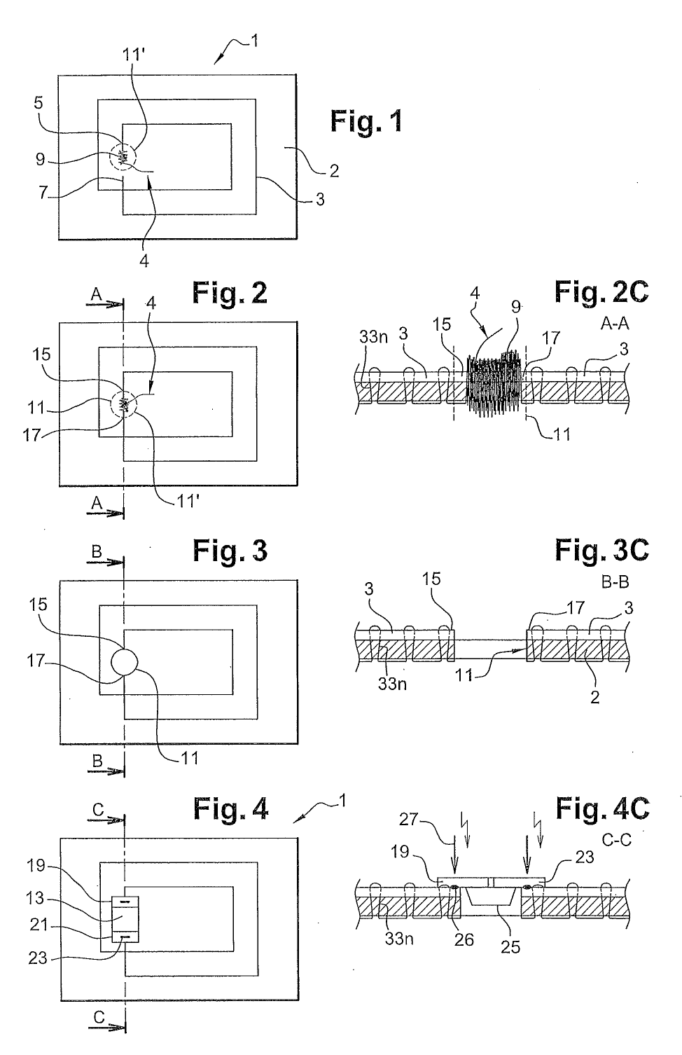

FIG. 1 shows a schematic view of a transponder antenna device according to an embodiment of the method of the invention;

FIGS. 2 and 2C illustrate two corresponding schematic views of a transponder antenna device according to a second embodiment to the method of the invention;

FIGS. 3 and 3C illustrate a step of the method including the removal of the end point in the preceding Figures and formation of the cavity at the same place;

FIGS. 4 and 4C illustrate a step of the method according to the second embodiment comprising the placing and connection of a module in the device of the preceding Figure;

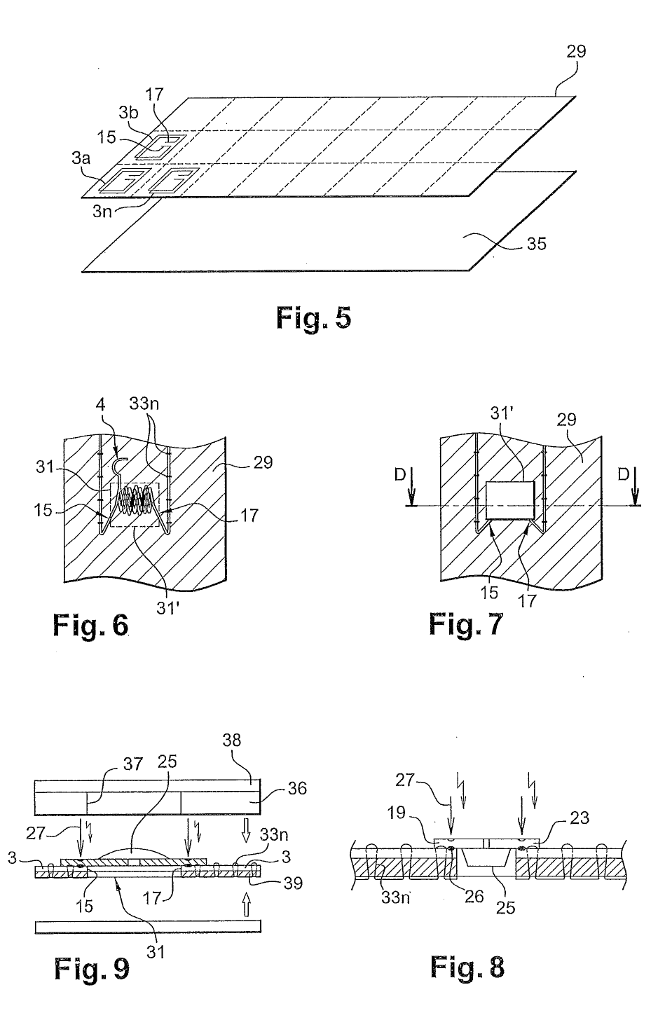

FIGS. 5, 6, 7, 8 illustrate a third embodiment of the invention on an industrial scale;

FIG. 9 illustrates another embodiment showing the placing and connection of a module of the invention.

As shown in FIG. 1, a device 1 complying with one embodiment of the invention includes a radio frequency transponder antenna 3, produced with two terminal sections 5, 7 on a support 2 by means of a wiring technique. The antenna windings include or constitute a conducting wire the characteristics of which are adapted to a radio frequency communication. This device is intended to be a radio frequency communication electronic product such as a contactless chip card, a passport or a by-product such as a contactless inlay.

In the example, the device 1 constitutes an inlay and the wire which is fixed by means of an embroidery technique preferably includes an isolating sheath enabling intersections on other windings without any short-circuit.

A terminal section 7 at the beginning of the antenna circuit started without any end point but ends with an end point 9 and if need be an idle wire end 4. This point is intended to be removed if necessary more particularly by punching.

In a non described alternative solution, a module can be connected on the one hand to the section 7 and on the other hand to the end point 9 or upstream of the end point.

In FIGS. 2, 2C another embodiment, the starting point 15 and end point 17 of the antenna reach the same zone 11, which is intended to be removed.

When the point is removed more particularly by punching in FIGS. 3, 3C the device includes, according to one characteristic, at least one terminal section 5 which extends up to the edge of the cavity 11 for the embodiment of FIG. 1 and two sections 15, 17 for that of FIG. 2.

In FIGS. 4, 4C the antenna 1 is more advanced and includes an electronic component 13 connected to the contact pads.

Conducting pads 19, 21 are connected by soldering 26 to the wire terminal sections by transfer of energy through said contact pads which include a mark 23 resulting from the pressure and activation of the soldering tool 27.

According to a preferred embodiment, the electronic component is positioned at least partly in cavity 11. There, at least one electronic chip and the coating thereof 25 are positioned in the cavity.

However, the component could also be positioned out of the cavity, for example by placing the module coating opposite the substrate (FIG. 9).

The component can be an electronic module 3 positioned on the substrate 4.

In the example, the component is an electronic module of the contactless type comprising a support film of the printed circuit type provided with an integrated circuit chip fixed on the support film and connected by a soldered wire or according to the flip-chip type technique (a chip turned upside down and connected with a conducting glue) to the contact pads extending on either side of the support film.

The module can be produced without a dielectric support film.

A coating 25 with a protection resin may coat the chip and the contacts thereof.

Now, a preferred embodiment of the method for producing the radio frequency transponder antenna device will be described.

In FIG. 5, the method includes the production of a substrate 29 including fibres such as a fabric or a very thin non woven substrate of the order of 0.80 to 300 μm in thickness (for example a fabric including warp and weft 48 dtex wires with a meshing of the order of 200 μm) and having dimensions making it possible to produce a plurality of antennas 3a-3n at the same time.

However, other isolating substrates are not excluded which can be for example a film or a sheet made of a polymer material, PVC, PET (polyethylene), paper, polyimide, synthetic leather or material which can be sewn or embroidered.

The substrate may have various thicknesses, generally smaller than or equal to that of a chip card 0.76 mm in thickness, so as to be used if need be as an inlay between two films or sheets or to be used as a support for a coating and/or printing sheet. Typically the substrate may have a thickness between for example 0.1 mm to 0.5 mm.

The method includes a step of forming the antenna or the plurality of antennas on the substrate, said antenna comprising two terminal connection sections 15, 17 by means of a wiring technique.

According to a characteristic of the embodiment, end points are made for the antenna wire at the end of one at least of said terminal sections.

In the example (FIG. 6), the terminal sections 15, 17 of the antenna or end points are superimposed or made in a zone 31 of the support intended to be removed.

The end point is selected among sewing, embroidery or knitting end points as a function of the technique used to produce the antenna. As a matter of fact, embroidery is used. A fixing wire 33 connects the antenna wire to the support of various places 33a-33n. The end may include several passages and/or superposition of antenna wires and fixation wires at the same place.

The handling of the supporting fabric of an embroidered antenna is very delicate (flexible and porous woven material). A material stabilising and reinforcing the fabric is fixed. The support is preferably associated with a sheet 35 which increases the behaviour and stability as regards dimensions and facilitates the handling of the substrate/antenna assembly.

Preferably, a reinforcing sheet is added after the production of the antenna but could be added beforehand. If it is performed beforehand, difficulties might arise for sewing or embroidering, and productivity or performances could be affected.

An effect similar to the addition of a sheet can be obtained by impregnating or coating a layer or spraying a product such as a coating, a primer, resin, polymer foam, gum able to stabilise the substrate as regards dimensions.

The assembly can be obtained by thermal soldering (melting of materials) or adding an adhesive (as a film, a liquid).

This step also makes it possible to give a compensation thickness to the substrate making it possible to receive a part of a component in the support while placing the latter.

At the following step, according to a characteristic, said end stop is removed (FIG. 7).

This removal is carried out preferably by punching a support at the end point and/or idle wire end 4 and includes thus the removal of material from the support opposite the end point and formation of a cavity 31, but it can also be executed by any other machining means or drilling of a hole or laser ablation of the end point with or without removal of material from the support.

At the next step (FIG. 7), according to one characteristic, conducting pads are placed opposite said terminal sections and said contact pads are connected to the terminal wire sections by soldering by transfer of energy through said contact pads.

In the example, the electronic component is previously fixed to the contact pads 19, 21 which belong to an electronic module. However, it is possible to place only metallisation or contact pads, dies, on the substrate so as to be able to connect the same to the terminal section of the antenna and then place a component such as an electronic chip which will subsequently be connected to these pads.

When placing the component, the latter is preferably positioned at least partially in said cavity; more particularly, the coated chip 25 is accommodated in the cavity 31 whereas the pads come to the surface of the substrate opposite the antenna connection terminal sections.

At the next step, the connection of these antenna terminal sections to the contact pads is carried out. This connection is preferably executed by means of a probe 27 of the thermo-compression type applied onto the contact pad which is pressed against the terminal wire section.

Other soldering means like an ultrasonic probe or an electric arc or even an adhesive conducting material can possibly be used if the antenna wires are stripped at the connection place.

The conducting wire of an embroidered antenna being a combination of the conducting material and one or several other synthetic fibres (PA, cotton, PES), the connection of the module with the embroidered antenna wire must be made in the thermo-compression/connection pads of the module/embroidered wire direction, so as to obtain a connection without deteriorating the soldering tool.

Soldering preferably uses an anvil (not shown) which rests against the recess of the terminal section of the antenna in the support; the anvil goes through at least the reinforcing sheet of layer opposite the terminal section to be connected in such a way that the portion to be connected is supported by the anvil during the soldering. The anvil or the needle may have a rectangular or square section for example between 0.3×1 mm² to 1×5 mm².

In the case where a chip is placed and connected to the pads for example by a flip-chip (upside down chip connection) a step of subsequent coating deposition may exist.

In FIG. 9, an alternative embodiment consists in placing a module without positioning it in the cavity of removal of the end point but above or at a distance from the cavity since the substrate is too thin at this stage for being accommodated in the formed cavity.

At least a compensation film 36, 38 with an accommodation cavity 37 of the whole or a part of the module is added above the module. Similarly, at least one coating sheet may complete the antenna device.

Upon completion of the connection process, the assembly is cut to the desired format along the dotted lines prior to or after receiving the coating or compensation or reinforcing sheets, if any.

If need be, the sheets 35, 36, 38 may include material able to absorb shocks or a certain deformation during the lamination or the utilisation and may then not include a cavity.

1. A method for producing a device comprising a radio frequency transponder antenna, said method comprising a step of producing the antenna with two terminal sections on a support by means of a wiring technique,
and further comprising a step of producing an end point on an antenna wire at the end of at least one of said terminal sections.

2. A method according to claim 1, wherein said method includes a step of removal of said end point.

3. A method according to claim 2, wherein the step of removal includes the removal of support material opposite the end point and the formation of a cavity.

4. A method according to claim 2, wherein the terminal sections of the antenna or end points are superimposed or produced in a supporting zone to be removed.

5. A method according to claim 1, wherein the end point is selected among stitch, embroidery or knitting barring stitches.

6. A method according to claim 1, wherein contact pads are placed opposite said terminal sections and said contact pads are connected to the terminal sections of the wire by soldering with transfer of energy through said contact pads.

7. A method according to claim 6, wherein one electronic component is fixed to the contact pads.

8. A method according to claim 3, wherein an electronic component is positioned at least partially in said cavity.

9. A method according to claim 1, wherein the support includes a fabric, and the method includes a step of fixing a material stabilising and reinforcing the fabric.

10. A device including a radio frequency transponder antenna, said antenna having two terminal sections on a support,
wherein at least one of said sections extends up to the edge of a cavity.

11. A device according to claim 10, wherein contact pads are connected by soldering to the terminal sections by transfer of energy through said contact pads.

12. A device according to claim 11, further including an electronic component connected to the contact pads.

13. A device according to claim 12, wherein the electronic component is positioned at least partially in said cavity.

14. A radio frequency communication electronic product including the device according to claim 10.

15. The radio frequency communication electronic product of claim 14, wherein the product comprises a contactless chip card.

16. The radio frequency communication electronic product of claim 14, wherein the product comprises a passport.

17. The radio frequency communication electronic product of claim 14, wherein the product comprises an inlay.

18. A method according to claim 2, wherein contact pads are placed opposite said terminal sections and said contact pads are connected to the terminal sections of the wire by soldering with transfer of energy through said contact pads.
